(19) United States
(12) Patent Application Publication
(10) Pub. No.: US 2024/0258547 A1
(43) Pub. Date: Aug. 1, 2024

(54) RADICAL SCAVENGERS FOR FUEL CELLS

(71) Applicant: Robert Bosch GmbH, Stuttgart (DE)

(72) Inventors: Soo KIM, Cambridge, MA (US); Ulrich BERNER, Stuttgart (DE); Charles TUFFILE, Swansea, MA (US)

(21) Appl. No.: 18/289,494

(22) PCT Filed: May 4, 2021
(86) PCT No.: PCT/US2021/030564

§ 371 Date: Nov. 3, 2023

(51) Int. Cl. H01M 8/1051; H01M 8/10; H01M 8/1004

(52) U.S. Cl. CPC H01M 8/1051; H01M 8/1004; H01M 2008/1095; H01M 2300/0091

(57) ABSTRACT

A fuel cell proton exchange membrane (PEM) includes a peroxide decomposition radical scavenger material, where the peroxide decomposition radical scavenger material is M/MOₓ (1≤x≤3), and M is Ta, W, Dy, Mo, La, Nd, V, Gd, Er, or Sm. The peroxide decomposition radical scavenger material may be mixed with at least one of Ce/CeOₓ (0.5≤x≤4) and Mn/MnOₓ (0.5≤x≤4).

### TECHNICAL FIELD

The present disclosure relates to radical scavengers for fuel cells, for example, radical scavengers for proton exchange membrane (PEM) fuel cells.

### BACKGROUND

Fuel cells have shown promise as an alternative power source for vehicles and other transportation applications. Fuel cells operate with a renewable energy carrier, such as hydrogen. Fuel cells also operate without emitting toxic or greenhouse gases. One of the current limitations of widespread adoption and use of this clean and sustainable technology is the relatively expensive cost of the fuel cell.

### SUMMARY

According to one embodiment, a fuel cell proton exchange membrane (PEM) is disclosed. The fuel cell PEM may include a peroxide decomposition radical scavenger material. The peroxide decomposition radical scavenger material may be M/MOₓ (1≤x≤3), where M is Ta, W, Dy, Mo, La, Nd, V, Gd, Er, or Sm. The peroxide decomposition radical scavenger material may be mixed with at least one of Ce/CeOₓ (0.5≤x≤4) and Mn/MnOₓ (0.5≤x≤4).

According to another embodiment, a fuel cell proton exchange membrane (PEM) is disclosed. The fuel cell PEM may include a peroxide decomposition radical scavenger material. The peroxide decomposition radical scavenger material may be a Ce—M—O compound, where M is a metal element other than Ce. For example, M may be Nb, Ta, Si, Ga, Sn, W, Dy, In, Zr, Ti, or Mo. The Ce—M—O compound may be Ce₃TaO₇, Ce₂Zr₂O₇, Ce₂Ti₂O₇, Ce₂TiO₅, Ce₂WO₆, Ce₂Si₂O₇, CeTa₃O₉, Ce₂Mo₄O₁₅, CeTaO₄, CeNb₃O₉, and CeNbO₄.

According to yet another embodiment, a fuel cell is disclosed. The fuel cell may include a membrane electrode assembly (MEA). The MEA may further include catalyst layers, a polymer electrolyte membrane (PEM) situated between the catalyst layers, and gas diffusion layers (GDLs) separated from the PEM by the catalyst layers. The fuel cell may also include bipolar plates connected to the GDLs. The PEM may have a peroxide decomposition radical scavenger material. The peroxide decomposition radical scavenger material may be M/MOₓ (1≤x≤3), where M is Ta, W, Dy, Mo, La, Nd, V, Gd, Er, or Sm. The peroxide decomposition radical scavenger material may be mixed with at least one of Ce/CeOₓ (0.5≤x≤4) and Mn/MnOₓ (0.5≤x≤4).

### BRIEF DESCRIPTION OF THE DRAWINGS

FIG. 1 depicts a schematic diagram of a computing platform that may be utilized to implement a data-driven materials screening method.

FIG. 2 depicts a schematic phase diagram showing a reaction enthalpy (eV/atom) of a reaction between MnO and H₂O₂ as a function of a molar fraction of MnO in a reaction environment.

FIG. 3A depicts a Pourbaix diagram of Ce showing possible thermodynamically stable phases of Ce in an aqueous electrochemical environment.

FIG. 3B depicts a Pourbaix diagram of Mn showing possible thermodynamically stable phases of Mn in an aqueous electrochemical environment.

FIG. 4 depicts a Pourbaix diagram of Ti showing possible thermodynamically stable phases of Ti in an aqueous electrochemical environment.

FIG. 5A is a schematic cross-sectional view of a fuel cell.

FIG. 5B is a schematic perspective view of components of the fuel cell shown in FIG. 5A.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for applications or implementations.

This present disclosure is not limited to the specific embodiments and methods described below, as specific components and/or conditions may, of course, vary. Furthermore, the terminology used herein is used only for the purpose of describing embodiments of the present disclosure and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The term “substantially” may be used herein to describe disclosed or claimed embodiments. The term “substantially” may modify any value or relative characteristic disclosed or claimed in the present disclosure. “Substantially” may signify that the value or relative characteristic it modifies is within +0%, 0.1%, 0.5%, 1%, 2%, 3%, 4%, 5% or 10% of the value or relative characteristic.

Reference is being made in detail to compositions, embodiments, and methods of embodiments known to the inventors. However, disclosed embodiments are merely exemplary of the present disclosure which may be embodied in various and alternative forms. Therefore, specific details disclosed herein are not to be interpreted as limiting, rather merely as representative bases for teaching one skilled in the art to variously employ the present disclosure.

PEM fuel cells show great potential as an alternative solution for energy production and consumption. Particularly, PEM fuel cells are being developed as electrical power sources for automobile applications. However, widespread adoption requires further research into lifetime and cost reduction for components used in the PEM fuel cells. These components may include a PEM, catalyst layers, and gas diffusion layers (GDLs).

A typical single PEM fuel cell is composed of a PEM, an anode layer, a cathode layer, and GDLs. These components form a membrane electrode assembly (MEA), which is surrounded by two flow field plates. A catalyst material, such as platinum (Pt) catalysts, is included in the catalyst layer of both the anode and cathode layers of the PEM fuel cell. At the anode layer, Pt catalysts catalyze a hydrogen oxidation reaction (HOR, H₂→2H⁺⁺2e⁻), where H₂ is oxidized to generate electrons and protons (H⁺). At the cathode layer, Pt catalysts catalyze an oxygen reduction reaction (ORR, 1/2O₂₊2H⁺⁺2e⁻→H₂O), where O₂ reacts with H⁺ and is reduced to form water.

During the operation of the PEM fuel cell, hydrogen peroxide (H₂O₂) may be generated in a fuel cell acidic environment. Decomposition of H₂O₂ may lead to the generation of radical species in the fuel cell acidic environment. The radical species may be hydroxyl radicals (•OH), hydrogen radicals (•H), and/or hydroperoxyl radicals (•OOH). The radical species may diffuse into the PEM and other fuel cell components. The formation of H₂O₂ may depend on the operating conditions of the PEM fuel cell. For example, under hot and dry conditions, more H₂O₂ can be generated, and therefore, more radical species can be generated in the fuel cell acidic environment. The radical species can attack the PEM and other fuel cell components, which consequently reduces the durability of the PEM fuel cell.

To prevent fuel cell components from attack by radical species, peroxide decomposition radical scavenger materials such as cerium (Ce)/cerium oxide (CeOₓ) or manganese (Mn)/manganese oxide (MnOₓ) have been utilized to remove the radical species in the fuel cell acidic environment. Although radical scavengers, for example, Ce/CeOₓ, can suppress the degradation of some fuel cell components, recent studies have indicated that because Ce can be ionized to Ce³⁺ ions in the fuel cell acidic environment, the ionized Ce can migrate from one location to another in the PEM fuel cell. Depending on a water flux and an electrical potential in the PEM fuel cell, Ce³⁺ ions may be transported and/or aggregated in certain fuel cell components, such as the PEM and/or the catalyst layers. As such, Ce/CeOₓ may not be an ideal to act as a radical scavenger to protect the fuel cell components from attack by radical species in the PEM fuel cell.

Aspects of the present disclosure relates to peroxide decomposition radical scavenger materials for fuel cells. As disclosed herein, first-principles density functional theory (DFT) algorithms, calculations and/or methodologies are used to model the chemical reactivities of metals (M), metal oxides (MOₓ or Ce—M—O), and Ce—Mn mixtures against H₂O₂ to identify radical scavengers that are comparably more effective than Ce/CeOₓ and/or Mn/MnOₓ and less soluble than Ce/CeOₓ and/or Mn/MnOₓ in a fuel cell acidic environment. Particularly, a data-driven materials screening method is employed for such identifications. The comparably superior radical scavengers may be incorporated in fuel cell components, such as the PEM, catalyst layers, and GDLs, to protect the fuel cell components from attack by radical species, thereby enhancing the durability of the PEM fuel cell. Depending on where the radical scavengers are incorporated into the fuel cell, a loading level of the radical scavengers may be in a range of 0.1 to 200 μg cm⁻². The loading level of the radical scavengers may be measured based on the weight of the metal element(s) in the radical scavengers, not metal oxide derivatives.

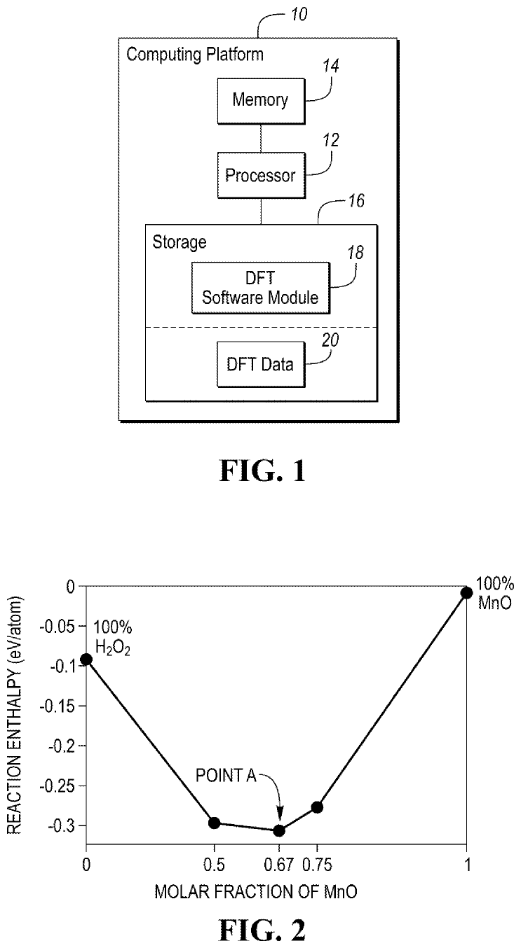

FIG. 1 depicts a schematic diagram of a computing platform that may be utilized to implement a data-driven materials screening method. The computing platform 10 may include a processor 12, a memory 14, and a non-volatile storage 16. The processor 12 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory 14 may include a single memory device or a number of memory devices including random access memory (RAM), volatile memory, non-volatile memory, static random-access memory (SRAM), dynamic random-access memory (DRAM), flash memory, cache memory, or any other device capable of storing information. The non-volatile storage 16 may include one or more persistent data storage devices such as a hard drive, optical drive, tape drive, non-volatile solid-state device, cloud storage or any other device capable of persistently storing information.

The processor 12 may be configured to read into memory and execute computer-executable instructions residing in a DFT software module 18 of the non-volatile storage 16 and embodying DFT slab model algorithms, calculations and/or methodologies of one or more embodiments. The DFT software module 18 may include operating systems and applications. The DFT software module 18 may be compiled or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by the processor 12, the computer-executable instructions of the DFT software module 18 may cause the computing platform 10 to implement one or more of the DFT algorithms and/or methodologies disclosed herein. The non-volatile storage 16 may also include DFT data 20 supporting the functions, features, calculations, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. The computer readable storage medium, which is inherently non-transitory, may include volatile and non-volatile, and removable and non-removable tangible media implemented in any method or technology for storage of information, such as computer-readable instructions, data structures, program modules, or other data. The computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in the computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

Referring to FIG. 1, the data-driven materials screening method may be utilized to identify radical scavengers that are comparably more effective than Ce/CeOₓ and/or Mn/MnOₓ and less soluble than Ce/CeOₓ and/or Mn/MnOₓ in a fuel cell acidic environment for the prevention of fuel cell components from degradation. The data-driven materials screening method may evaluate radical scavenger candidates, including metal elements (M), metal oxides (MOₓ or Ce—M—O), and Ce—Mn mixtures, in terms of their chemical reactivities against H₂O₂ under similar conditions.

To better understand the chemical reactivity of a radical scavenger candidate against H₂O₂, the data-driven materials screening method is first used to examine the chemical reactivities of Ce/CeOₓ and Mn/MnOₓ against H₂O₂ under similar conditions. The chemical reactivities of Ce/CeOₓ and Mn/MnOₓ against H₂O₂ may then be used as references for the identification of radical scavenger candidates that are comparably more effective than Ce/CeOₓ and/or Mn/MnOₓ and less soluble than Ce/CeOₓ and/or Mn/MnOₓ in a fuel cell acidic environment.

FIG. 2 depicts a schematic phase diagram showing a reaction enthalpy (eV/atom) of a reaction between MnO and H₂O₂ as a function of a molar fraction of MnO in a reaction environment. The reaction enthalpy represents a reaction energy per reaction atom. As shown in FIG. 2, the molar faction of MnO is in a range of 0 and 1. When the molar faction of MnO is 0, there is no MnO but 100% H₂O₂ in the reaction environment. Conversely, when the molar faction of MnO is 1, there is no H₂O₂ but 100% MnO in the reaction environment. As the molar fraction of MnO increases from 0, the most stable decomposition reaction between MnO and H₂O₂ may occur at Point A, where the molar fraction of MnO is about 0.67 and the reaction enthalpy of the reaction is about −0.312 eV/atom. Reaction (1) is included hereby to illustrate the most stable decomposition reaction:

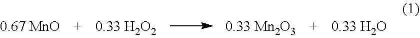

According to reaction (1), after reacting with H₂O₂, MnO is turned into Mn₂O₃. Point A also represents the situation where radical species (e.g. •OH) and the radical scavenger, herein MnO, are abundantly present in the reaction environment.

Next, using the data-driven materials screening method, chemical reactivities of Ce/CeOₓ against H₂O₂ may be evaluated. First, Ce may react with H₂O₂ to generate CeH₃ and Ce₇O₁₂, (i.e., can also be written as CeO_{1.71}). Reaction (2) is included hereby to illustrate this reaction:

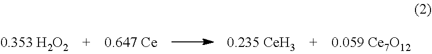

According to reaction (2), the most stable decomposition reaction between Ce and H₂O₂ may occur when the molar fraction of Ce is about 0.647. The reaction enthalpy of reaction (2) is about −1.742 eV/atom. The reaction products CeH₃ and Ce₇O₁₂ may further react with H₂O₂ to fully oxidize Ce to CeO₂. CeO₂ may not react with H₂O₂. Reaction (3) is included hereby to illustrate the reaction between CeH₃ and H₂O₂:

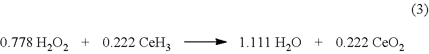

According to reaction (3), the most stable decomposition reaction between CeH₃ and H₂O₂ may occur when the molar fraction of CeH₃ is about 0.222. The reaction enthalpy of reaction (3) is about −0.938 eV/atom. Reaction (4) is also included hereby to illustrate the reaction between Ce₇O₁₂ and H₂O₂:

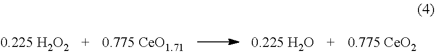

According to reaction (4), the most stable decomposition reaction between CeO_{1.71} and H₂O₂ may occur when the molar fraction of CeO_{1.71} is about 0.775. The reaction enthalpy of reaction (3) is about −0.328 eV/atom.

Table 1 provides information of the most stable decomposition reactions between Ce/CeOₓ and H₂O₂. Particularly, Table 1 provides a reaction equation of the most stable decomposition reaction of each chain reaction. Table 1 further provides a molar fraction between H₂O₂ and each Ce-containing compound. Table 1 also provides a first penalty point (e.g. PP1) regarding the molar fraction, where PP1 of 1.00 is assigned to the reaction between Ce and H₂O₂. In addition, Table 1 provides a reaction enthalpy of each chain reaction and assigns a second penalty point (e.g. PP2) regarding the reaction enthalpy of each chain reaction, where PP2 of 1.00 is assigned to the reaction between Ce and H₂O₂.

Furthermore, Table 1 provides a sum of the first and second penalty points, i.e., ΣPP. As shown in Table 1, ΣPP(Ce) equals PP1+ PP2, which is 2.00. To adjust the ratio of CeH₃ between reactions (2) and (3) and the ratio of Ce₇O₁₂ (i.e., CeO_{1.71}) between reactions (2) and (4), Table 1 provides a ratio R, where, for CeH₃, R(CeH₃) equals 0.235/0.222, which is about 105.9%; for Ce₇O₁₂ (i.e., CeO_{1.71}), R(Ce₇O₁₂) equals 0.059/(0.775*7), which is about 1.1%. Table 1 also provides an adjusted sum of the first and second penalty points, i.e., ΣPP′, where, for CeH₃, ΣPP′(CeH₃) equals 2.01*105.9%, which is about 2.13; for Ce₇O₁₂ (i.e., CeO_{1.71}), ΣPP′(Ce₇O₁₂) equals 7.19*1.1%, which is about 0.08. Table 1 further provides a total of the adjusted sum of penalty points for all the Ce/CeOₓ chain reactions, i.e., reaction (2), (3) and (4), which is about 4.21.

TABLE 1
Information of the most stable decomposition reactions between Ce/CeOₓ and H₂O₂.

| | | | | Reaction | | | | |
|---|---|---|---|---|---|---|---|---|
| | Equation of the most stable decomposition reaction | Molar | | enthalpy | | | | |
| Ce/CeOₓ | between Ce/CeOₓ and H₂O₂ | fraction | PP1 | (eV/atom) | PP2 | ΣPP | R (%) | ΣPP′ |
| Ce | 0.353 H₂O₂ + 0.647 Ce → 0.235 CeH₃ + 0.059 Ce₇O₁₂ | 0.55 | 1.00 | −1.742 | 1.00 | 2.00 | — | 2.00 |
| CeH₃ | 0.778 H₂O₂ + 0.222 CeH₃ → 1.111 H₂O + 0.222 CeO₂ | 3.50 | 0.16 | −0.938 | 1.86 | 2.01 | 105.9 | 2.13 |
| CeO_{1.71} | 0.225 H₂O₂ + 0.775 CeO_{1.71} → 0.225 H₂O + 0.775 CeO₂ | 0.29 | 1.88 | −0.328 | 5.31 | 7.19 | 1.1 | 0.08 |
| CeO₂ | No reaction | — | — | — | — | — | — | — |

| | |
|---|---|
| Total of the adjusted sum of penalty points for Ce/CeOₓ | 4.21 |

Next, using the data-driven materials screening method, chemical reactivities of Mn/MnOₓ against H₂O₂ may also be evaluated. First, Mn may react with H₂O₂ to generate MnO. Reaction (5) is included hereby to illustrate this reaction:

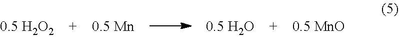

According to reaction (5), the most stable decomposition reaction between Mn and H₂O₂ may occur when the molar fraction of Mn is about 0.5. The reaction enthalpy of reaction (5) is about −0.863 eV/atom. The reaction product MnO may further react with H₂O₂ to give Mn₂O₃. Reaction (6) is included hereby to illustrate the reaction between MnO and H₂O₂:

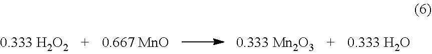

According to reaction (6), the most stable decomposition reaction between MnO and H₂O₂ may occur when the molar fraction of MnO is about 0.667. The reaction enthalpy of reaction (6) is about −0.312 eV/atom. The reaction product Mn₂O₃ (i.e., MnO_{1.5}) may further react with H₂O₂ to fully oxidize Mn to MnO₂. MnO₂ may not react with H₂O₂. Reaction (7) is included hereby to illustrate the reaction between Mn₂O₃ (i.e., MnO_{1.5}) and H₂O₂:

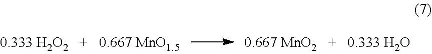

According to reaction (7), the most stable decomposition reaction between MnO_{1.5} and H₂O₂ may occur when the molar fraction of MnO_{1.5} is about 0.667. The reaction enthalpy of reaction (7) is about −0.123 eV/atom.

Table 2 provides information of the most stable decomposition reactions between Mn/MnOₓ and H₂O₂. Particularly, Table 2 provides a reaction equation of the most stable decomposition reaction of each chain reaction. The reaction between Ce and H₂O₂ in Table 1 is used herein as a reference. Table 2 provides a molar fraction between H₂O₂ and each Mn-containing compound. Table 1 also provides a third penalty point (e.g. PP3) regarding the molar fraction, where PP3 equals 0.55 (i.e., the molar fraction between H₂O₂ and Ce as shown in Table 1) divided by the molar fraction between H₂O₂ and Mn or Mn-containing compound. For example, the molar fraction between H₂O₂ and Mn is 1.00, and therefore, PP3(Mn) equals 0.55/1.00, which is 0.55.

Table 2 further provides a reaction enthalpy of each chain reaction and assigns a fourth penalty point (e.g. PP4) regarding the reaction enthalpy of each chain reaction, where PP4 equals −1.742 eV/atom (i.e., the reaction enthalpy between H₂O₂ and Ce as shown in Table 1) divided by the reaction enthalpy between H₂O₂ and Mn or Mn-containing compound. For example, the reaction enthalpy of the reaction between H₂O₂ and Mn is about −0.863 eV/atom, and therefore, PP4(Mn) equals−1.742/−0.863, which is about 2.02.

Furthermore, Table 2 provides a sum of the third and fourth penalty points, i.e., ΣPP. As shown in Table 2, ΣPP(Mn) equals PP3+ PP4, which is about 2.56. To adjust the ratio of MnO between reactions (5) and (6) and the ratio of Mn₂O₃ (i.e., MnO_{1.5}) between reactions (6) and (7), Table 2 provides a ratio R, where, for MnO, R(MnO) equals 0.5/0.667, which is about 75%; for Mn₂O₃ (i.e., MnO_{1.5}), R(Mn₂O₃) equals 0.333/(0.667*2), which is about 25%. Table 2 also provides an adjusted sum of the third and fourth penalty points, i.e., ΣPP′, where, for MnO, ΣPP′(MnO) equals 6.68*75%, which is about 5.00; for Mn₂O₃ (i.e., MnO_{1.5}), ΣPP′(Mn₂O₃) equals 15.26*25%, which is about 3.81. Table 2 further provides a total of the adjusted sum of penalty points for all the Mn/MnOₓ chain reactions, i.e., reaction (5), (6) and (7), which is about 11.38.

TABLE 2
Information of the most stable decomposition reactions between Mn/MnOₓ and H₂O₂.

| | | | | Reaction | | | | |
|---|---|---|---|---|---|---|---|---|
| | Equation of the most stable decomposition reaction | Molar | | enthalpy | | | | |
| Mn/MnOₓ | between Mn/MnOₓ and H₂O₂ | fraction | PP3 | (eV/atom) | PP4 | ΣPP | R (%) | ΣPP′ |
| Ce (reference) | 0.353 H₂O₂ + 0.647 Ce → 0.235 CeH₃ + 0.059 Ce₇O₁₂ | 0.55 | 1.00 | −1.742 | 1.00 | 2.00 | — | 2.00 |
| Mn | 0.5 H₂O₂ + 0.5 Mn → 0.5 H₂O + 0.5 MnO | 1.00 | 0.55 | −0.863 | 2.02 | 2.56 | — | 2.56 |
| MnO | 0.333 H₂O₂ + 0.667 MnO → 0.333 Mn₂O₃ + 0.333 H₂O | 0.50 | 1.09 | −0.312 | 5.58 | 6.68 | 75 | 5.00 |
| MnO_{1.5} | 0.333 H₂O₂ + 0.667 MnO_{1.5} → 0.667 MnO₂ + 0.333 H₂O | 0.50 | 1.09 | −0.123 | 14.16 | 15.26 | 25 | 3.81 |
| MnO₂ | No reaction | — | — | — | — | — | — | — |

| | |
|---|---|
| Total of the adjusted sum of penalty points for Mn/MnOₓ | 11.38 |

In view of Tables 1 and 2, the total of the adjusted sum of penalty points for reactions between Mn/MnOₓ and H₂O₂ is about 11.38, which is larger than that (i.e. 4.21) for reactions between Ce/CeOₓ and H₂O₂. This indicates that Ce/CeOₓ may react with H₂O₂ more favorably than Mn/MnOₓ in similar reaction environments, making Ce/CeOₓ a relatively better radical scavenger than Mn/MnOₓ.

Apart from those CeOₓ and MnOₓ compounds in Tables 1 and 2, other CeOₓ and MnOₓ compounds with different oxidation states may also react with H₂O₂ in similar reaction environments. Using the data-driven materials screening method as described above, chemical reactivities of other CeOₓ and/or MnOₓ compounds against H₂O₂ may further be evaluated. Some of these CeOₓ and MnOₓ compounds include CeO, CeO_{1.5}, CeO_{1.8}, CeO_{1.81}, CeO_{1.88}, and MnO_{1.33}.

Table 3 provides information of the most stable decomposition reaction between each of the CeOₓ and MnOₓ compounds and H₂O₂. Particularly, Table 3 provides a reaction equation of the most stable decomposition reaction of each reaction. The reaction between Ce and H₂O₂ in Table 1 is used herein as a reference. Table 3 provides a molar fraction between H₂O₂ and each of the CeOₓ and MnOₓ compounds. Table 3 further provides a fifth penalty point (e.g. PP5) regarding the molar fraction, where PP5 equals 0.55 (i.e., the molar fraction between H₂O₂ and Ce as shown in Table 1) divided by the molar fraction between H₂O₂ and each of the CeOₓ and MnOₓ compounds. For example, the molar fraction between H₂O₂ and CeO is 1.00, and therefore, PP5(CeO) equals 0.55/1.00, which is 0.55.

In addition, Table 3 provides a reaction enthalpy of each reaction and assigns a sixth penalty point (e.g. PP6) regarding the reaction enthalpy of each reaction, where PP6 equals−1.742 eV/atom (i.e., the reaction enthalpy between H₂O₂ and Ce as shown in Table 1) divided by the reaction enthalpy between H₂O₂ and each of the CeOₓ and MnOₓ compounds. For example, the reaction enthalpy of the reaction between H₂O₂ and CeO is about −0.943 eV/atom, and therefore, PP6(CeO) equals−1.742/−0.943, which is about 1.85. Furthermore, Table 3 provides a sum of the fifth and sixth penalty points, i.e., ΣPP=PP5+ PP6.

TABLE 3
Information of the most stable decomposition reaction
between H₂O₂ and each of the CeOₓ and MnOₓ compounds.

| | | | | Reaction | | |
|---|---|---|---|---|---|---|
| | Equation of the most stable decomposition reaction | Molar | | enthalpy | | |
| CeOₓ or MnOₓ | between H₂O₂ and CeOₓ or MnOₓ | fraction | PP5 | (eV/atom) | PP6 | ΣPP |
| Ce (reference) | 0.353 H₂O₂ + 0.647 Ce → 0.235 CeH₃ + 0.059 Ce₇O₁₂ | 0.55 | 1.00 | −1.742 | 1.00 | 2.00 |
| CeO | 0.5 H₂O₂ + 0.5 CeO → 0.5 H₂O + 0.5 CeO₂ | 1.00 | 0.55 | −0.943 | 1.85 | 2.39 |
| CeO_{1.5} | 0.333 H₂O₂ + 0.667 CeO_{1.5} → 0.333 H₂O + 0.667 CeO₂ | 0.50 | 1.09 | −0.563 | 3.09 | 4.19 |
| CeO_{1.8} | 0.167 H₂O₂ + 0.833 CeO_{1.8} → 0.167 H₂O + 0.833 CeO₂ | 0.20 | 2.72 | −0.226 | 7.71 | 10.43 |
| CeO_{1.81} | 0.16 H₂O₂ + 0.84 CeO_{1.81} → 0.16 H₂O + 0.84 CeO₂ | 0.19 | 2.86 | −0.216 | 8.06 | 10.93 |
| CeO_{1.88} | 0.107 H₂O₂ + 0.893 CeO_{1.88} → 0.107 H₂O + 0.893 CeO₂ | 0.12 | 4.55 | −0.145 | 12.01 | 16.57 |
| MnO_{1.33} | 0.401 H₂O₂ + 0.599 MnO_{1.33} → 0.599 MnO₂ + 0.401 H₂O | 0.67 | 0.81 | −0.174 | 10.01 | 10.83 |

According to the sum of the fifth and sixth penalty points in Table 3, CeO, CeO_{1.5}, and CeO_{1.5} appear to react with H₂O₂ more favorably than MnO_{1.33}, and the reactivity of CeO_{1.51} against H₂O₂ appears to be comparable to that of MnO_{1.33}. Table 3 also shows that CeO_{1.88} reacts with H₂O₂ less favorably than MnO_{1.33}. Furthermore, Table 3 appears to suggest that metal oxides with lower oxidation states may react with H₂O₂ more favorably than those with higher oxidation states. For example, CeO_{1.5} appears to react with H₂O₂ more favorably than CeO_{1.88} in similar reaction environments.

Next, the data-driven materials screening method is used to evaluate other metal elements except Ce and Mn to identify comparable radical scavengers for fuel cells. Some of these metal elements may include, aluminum (Al), silicon (Si), titanium (Ti), vanadium (V), chromium (Cr), iron (Fe), cobalt (Co), nickel (Ni), copper (Cu), zinc (Zn), gallium (Ga), yttrium (Y), zirconium (Zr), niobium (Nb), molybdenum (Mo), indium (In), tin (Sn), antimony (Sb), tellurium (Te), lanthanum (La), praseodymium (Pr), neodymium (Nd), samarium (Sm), europium (Eu), gadolinium (Gd), dysprosium (Dy), erbium (Er), tantalum (Ta), tungsten (W), and bismuth (Bi).

Table 4 provides information of the most stable decomposition reaction between each metal element and H₂O₂. The decomposition product in each reaction is obtained using “interface reactions” module kit, available on materialsproject.org. Particularly, Table 4 provides a reaction equation of the most stable decomposition reaction of each reaction. The reaction between Ce and H₂O₂ in Table 1 is used herein as a reference. Table 4 provides a molar fraction between H₂O₂ and each metal element. Table 4 further provides a seventh penalty point (e.g. PP7) regarding the molar fraction, where PP7 equals 0.55 (i.e., the molar fraction between H₂O₂ and Ce as shown in Table 1) divided by the molar fraction between H₂O₂ and each metal element. For example, the molar fraction between H₂O₂ and Al is 0.75, and therefore, PP7(Al) equals 0.55/0.75, which is 0.73.

In addition, Table 4 provides a reaction enthalpy of each reaction and assigns an eighth penalty point (e.g. PP8) regarding the reaction enthalpy of each reaction, where PP8 equals −1.742 eV/atom (i.e., the reaction enthalpy between H₂O₂ and Ce as shown in Table 1) divided by the reaction enthalpy between H₂O₂ and each metal element. For example, the reaction enthalpy of the reaction between H₂O₂ and Al is about −1.428 eV/atom, and therefore, PP8(Al) equals−1.742/−1.428, which is about 1.22. Furthermore, Table 4 provides a sum of the seventh and eighth penalty points, i.e., ΣPP(M)=PP7+ PP8.

TABLE 4
Information of the most stable decomposition reaction between H₂O₂ and each metal element (M).

| | | | | Reaction | | |
|---|---|---|---|---|---|---|
| | Equation of the most stable decomposition | Molar | | enthalpy | | ΣPP |
| M | reaction between H₂O₂ and each M | fraction | PP7 | (eV/atom) | PP8 | (M) |
| Ce (reference) | 0.353 H₂O₂ + 0.647 Ce → 0.235 CeH₃ + 0.059 Ce₇O₁₂ | 0.55 | 1.00 | −1.742 | 1.00 | 2.00 |
| Mn | 0.5 H₂O₂ + 0.5 Mn → 0.5 H₂O + 0.5 MnO | 1.00 | 0.55 | −0.863 | 2.02 | 2.56 |
| Al | 0.429 H₂O₂ + 0.571 Al → 0.286 Al₂O₃ + 0.429 H₂ | 0.75 | 0.73 | −1.428 | 1.22 | 1.95 |
| Si | 0.5 H₂O₂ + 0.5 Si → 0.5 SiO₂ + 0.5 H₂ | 1.00 | 0.55 | −1.199 | 1.45 | 2.00 |
| Ti | 0.3 H₂O₂ + 0.7 Ti → 0.2 Ti₂O₃ + 0.3 TiH₂ | 0.43 | 1.27 | −1.415 | 1.23 | 2.50 |
| V | 0.6 H₂O₂ + 0.4 V → 0.4 VHO₂ + 0.4 H₂O | 1.50 | 0.36 | −0.985 | 1.77 | 2.13 |
| Cr | 0.4 Cr + 0.6 H₂O₂ → 0.4 CrHO₂ + 0.4 H₂O | 1.50 | 0.36 | −0.936 | 1.86 | 2.22 |
| Fe | 0.5 H₂O₂ + 0.5 Fe → 0.5 H₂O + 0.5 FeO | 1.00 | 0.55 | −0.757 | 2.30 | 2.85 |
| Co | 0.5 H₂O₂ + 0.5 Co → 0.5 H₂O + 0.5 CoO | 1.00 | 0.55 | −0.630 | 2.77 | 3.31 |
| Ni | 0.5 H₂O₂ + 0.5 Ni → 0.5 H₂O + 0.5 NiO | 1.00 | 0.55 | −0.481 | 3.62 | 4.17 |
| Cu | 0.5 H₂O₂ + 0.5 Cu → 0.5 H₂O + 0.5 CuO | 1.00 | 0.55 | −0.446 | 3.91 | 4.45 |
| Zn | 0.5 H₂O₂ + 0.5 Zn → 0.5 Zn(HO)₂ | 1.00 | 0.55 | −0.787 | 2.21 | 2.76 |
| Ga | 0.6 H₂O₂ + 0.4 Ga → 0.4 GaHO₂ + 0.4 H₂O | 1.50 | 0.36 | −0.884 | 1.97 | 2.33 |
| Y | 0.333 H₂O₂ + 0.667 Y → 0.222 YH₃ + 0.222 Y₂O₃ | 0.50 | 1.09 | −1.888 | 0.92 | 2.02 |
| Zr | 0.667 Zr + 0.333 H₂O₂ → 0.333 ZrO₂ + 0.333 ZrH₂ | 0.50 | 1.09 | −1.599 | 1.09 | 2.18 |
| Nb | 0.707 H₂O₂ + 0.293 Nb → 0.024 Nb₁₂O₂₉ + 0.707 H₂O | 2.41 | 0.23 | −1.051 | 1.66 | 1.88 |
| Mo | 0.667 H₂O₂ + 0.333 Mo → 0.667 H₂O + 0.333 MoO₂ | 2.00 | 0.27 | −0.785 | 2.22 | 2.49 |
| In | 0.6 H₂O₂ + 0.4 In → 0.4 In(HO)₃ | 1.50 | 0.36 | −0.800 | 2.18 | 2.54 |
| Sn | 0.667 H₂O₂ + 0.333 Sn → 0.333 SnO₂ + 0.667 H₂O | 2.00 | 0.27 | −0.781 | 2.23 | 2.50 |
| Sb | 0.6 H₂O₂ + 0.4 Sb → 0.2 Sb₂O₃ + 0.6 H₂O | 1.50 | 0.36 | −0.699 | 2.49 | 2.86 |
| Te | 0.667 H₂O₂ + 0.333 Te → 0.333 TeO₂ + 0.667 H₂O | 2.00 | 0.27 | −0.575 | 3.03 | 3.30 |
| La | 0.333 H₂O₂ + 0.667 La → 0.667 LaHO | 0.50 | 1.09 | −1.868 | 0.93 | 2.03 |
| Pr | 0.333 H₂O₂ + 0.667 Pr → 0.222 PrH₃ + 0.222 Pr₂O₃ | 0.50 | 1.09 | −1.710 | 1.02 | 2.11 |
| Nd | 0.333 H₂O₂ + 0.667 Nd → 0.667 NdHO | 0.50 | 1.09 | −1.787 | 0.97 | 2.07 |
| Sm | 0.333 H₂O₂ + 0.667 Sm → 0.222 Sm₂O₃ + 0.222 SmH₃ | 0.50 | 1.09 | −1.813 | 0.96 | 2.05 |
| Eu | 0.25 H₂O₂ + 0.75 Eu → 0.25 EuH₂ + 0.5 EuO | 0.33 | 1.64 | −1.507 | 1.16 | 2.79 |
| Gd | 0.667 Gd + 0.333 H₂O₂ → 0.222 GdH₃ + 0.222 Gd₂O₃ | 0.50 | 1.09 | −1.838 | 0.95 | 2.04 |
| Dy | 0.333 H₂O₂ + 0.667 Dy → 0.222 DyH₃ + 0.222 Dy₂O₃ | 0.50 | 1.09 | −1.910 | 0.91 | 2.00 |
| Er | 0.333 H₂O₂ + 0.667 Er → 0.222 ErH₃ + 0.222 Er₂O₃ | 0.50 | 1.09 | −1.938 | 0.90 | 1.99 |
| Ta | 0.444 Ta + 0.556 H₂O₂ → 0.222 Ta₂O₅ + 0.556 H₂ | 1.25 | 0.44 | −1.156 | 1.51 | 1.94 |
| W | 0.75 H₂O₂ + 0.25 W → 0.25 WO₃ + 0.75 H₂O | 3.00 | 0.18 | −0.745 | 2.34 | 2.52 |
| Bi | 0.6 H₂O₂ + 0.4 Bi → 0.2 Bi₂O₃ + 0.6 H₂O | 1.50 | 0.36 | −0.661 | 2.64 | 3.00 |

As discussed in Tables 1 and 2, the sum of the penalty points for the reaction between Ce and H₂O₂ is 2, and that for the reaction between Mn and H₂O₂ is 2.56. Referring to Table 4, metal elements whose sum of penalty points above 2.56 are excluded for further consideration as radical scavenger candidates for fuel cells. These metal elements appear to be Fe, Co, Ni, Cu, Zn, Sb, Te, Eu, and Bi. The remaining metal elements, including Al, Si, Ti, V, Cr, Ga, Y, Zr, Nb, Mo, In, Sn, La, Pr, Nd, Sm, Gd, Dy, Er, Ta, and W, are to be considered as radical scavenger candidates for fuel cells.

Using the data-driven materials screening method, chemical reactivities of each M/MOₓ and H₂O₂ may be evaluated, where M may be Al, Si, Ti, V, Cr, Ga, Y, Zr, Nb, Mo, In, Sn, La, Pr, Nd, Sm, Gd, Dy, Er, Ta, and W. Table 5 provides information of the most stable decomposition reactions between each M/MOₓ and H₂O₂. Particularly, Table 5 provides a reaction equation of the most stable decomposition reaction of each chain reaction. The reaction between Ce/CeOₓ and H₂O₂ in Table 1 is used herein as a reference. Table 5 provides a molar fraction between H₂O₂ and each M-containing compound. Table 5 further provides a ninth penalty point (e.g. PP9) regarding the molar fraction, where PP9 equals 0.55 (i.e., the molar fraction between H₂O₂ and Ce as shown in Table 1) divided by the molar fraction between H₂O₂ and M or M-containing compound. For example, the molar fraction between H₂O₂ and Al is 0.75, and therefore, PP9(Al) equals 0.55/0.75, which is 0.73.

In addition, Table 5 provides a reaction enthalpy of each reaction and assigns a tenth penalty point (e.g. PP10) regarding the reaction enthalpy of each reaction, where PP10 equals−1.742 eV/atom (i.e., the reaction enthalpy between H₂O₂ and Ce as shown in Table 1) divided by the reaction enthalpy between H₂O₂ and M or M-containing compound. For example, the reaction enthalpy of the reaction between H₂O₂ and Al is about −1.428 eV/atom, and therefore, PP10(Al) equals−1.742/−1.428, which is about 1.22.

Furthermore, Table 5 provides a sum of the tenth and eleventh penalty points, i.e., ΣPP=PP10+ PP11. As shown in Table 5, some M/MOₓ react with H₂O₂ through multiple steps. To adjust the ratio of MOₓ between the chain reactions, Table 5 provides a ratio R. For example, for Al/AlOₓ, after 0.571 Al reacting with 0.429 H₂O₂, the product Al₂O₃may continue reacting with H₂O₂ until Al is fully oxidized to Al₁₁O₁₈. Therefore, to adjust the ratio of Al₂O₃(i.e., AlO_{1.5}) between the two chain reactions, a ratio R(Al₂O₃) is calculated as 0.286/(0.88*2), which is about 162.5%.

Table 5 further provides an adjusted sum of the ninth and tenth penalty points, i.e., ΣPP′. For example, for Al₂O₃(i.e., AlO_{1.5}), the adjusted sum of PP9(Al₂O₃) and PP10(Al₂O₃) is calculated as 20.56*162.5%, which is about 33.46. Table 5 further provides a total of the adjusted sum of penalty points for all the M/MOₓ chain reactions, i.e. ΣPP″. For example, for Al/AlOₓ, the total of the adjust sum of penalty points is about 35.41.

TABLE 5
Information of the most stable decomposition reactions between M/MOₓ and H₂O₂.

| | | | | Reaction | | | | | |
|---|---|---|---|---|---|---|---|---|---|
| | Equation of the most stable decomposition reactions | Molar | | enthalpy | | | | | |
| M/MOₓ | between M/MOₓ and H₂O₂ | fraction | PP9 | (eV/atom) | PP10 | ΣPP | R (%) | ΣPP′ | ΣPP″ |
| Ce | 0.353 H₂O₂ + 0.647 Ce → 0.235 CeH₃ + 0.059 Ce₇O₁₂ | 0.55 | 1.00 | .1.742 | 1.00 | 2.00 | — | 2.00 | 4.21 |
| CeH₃ | 0.778 H₂O₂ + 0.222 CeH₃ → 1.111 H₂O + 0.222 CeO₂ | 3.50 | 0.16 | −0.938 | 1.86 | 2.0 | 105.9 | 2.13 | (reference) |
| CeO_{1.71} | 0.225 H₂O₂ + 0.775 CeO_{1.71} → 0.225 H₂O + 0.775 CeO₂ | 0.29 | 1.88 | −0.328 | 5.31 | 7.19 | 1.1 | 0.08 | |
| CeO₂ | No reaction | — | — | — | — | — | — | — | |
| Mn | 0.5 H₂O₂ + 0.5 Mn → 0.5 H₂O + 0.5 MnO | 1.00 | 0.55 | −0.863 | 2.02 | 2.56 | — | 2.56 | 11.38 |
| MnO | 0.333 H₂O₂ + 0.667 MnO → 0.333 Mn₂O₃ + 0.333 H₂O | 0.50 | 1.09 | −0.312 | 5.58 | 6.68 | 75 | 5.00 | |
| MnO_{1.5} | 0.333 H₂O₂ + 0.667 MnO_{1.5} → 0.667 MnO₂ + 0.333 H₂O | 0.50 | 1.09 | −0.123 | 14.16 | 15.26 | 25 | 3.8 | |
| MnO₂ | No reaction | — | — | — | — | — | — | — | |
| Al | 0.429 H₂O₂ + 0.571 Al → 0.286 Al₂O₃ + 0.429 H₂ | 0.75 | 0.73 | −1.428 | 1.22 | 1.95 | — | 1.95 | 35.41 |
| AlO_{1.5} | 0.12 H₂O₂ + 0.88 AlO_{1.5} → 0.08 Al₁₁O₁₈ + 0.12 H₂O | 0.14 | 4.00 | −0.105 | 16.59 | 20.59 | 162.5 | 33.46 | |
| Al₁₁O₁₈ | No reaction | — | — | — | — | — | — | — | |
| Si | 0.5 H₂O₂ + 0.5 Si → 0.5 SiO₂ + 0.5 H₂ | 1.00 | 0.55 | −1.199 | 1.45 | 2.00 | — | 2.00 | 2.00 |
| SiO₂ | No reaction | — | — | — | — | — | — | — | |
| Ti | 0.3 H₂O₂ + 0.7 Ti → 0.2 Ti₂O₃ + 0.3 TiH₂ | 0.43 | 1.27 | −1.415 | 1.23 | 2.50 | — | 2.50 | 5.62 |
| TiO_{1.5} | 0.333 H₂O₂ + 0.667 TiO_{1.5} → 0.333 H₂O + 0.667 TiO₂ | 0.50 | 1.09 | −0.537 | 3.24 | 4.34 | 15.0 | 0.65 | |
| TiH₂ | 0.75 H₂O₂ + 0.25 TiH₂ → H₂O + 0.25 TiO₂ | 3.00 | 0.18 | −0.929 | 1.88 | 2.06 | 120.0 | 2.47 | |
| TiO₂ | No reaction | — | — | — | — | — | — | — | |
| V | 0.6 H₂O₂ + 0.4 V → 0.4 VHO₂ + 0.4 H₂O | 1.50 | 0.36 | −0.985 | 1.77 | 2.13 | — | 2.13 | 8.26 |
| VHO₂ | 0.5 VHO₂ + 0.5 H₂O₂ → 0.25 V₂O₅ + 0.75 H₂O | 1.00 | 0.55 | −0.245 | 7.11 | 7.66 | 80.0 | 6.12 | |
| VO_{2.5} | No reaction | — | — | — | — | — | — | — | |
| Cr | 0.4 Cr + 0.6 H₂O₂ → 0.4 CrHO₂ + 0.4 H₂O | 1.50 | 0.36 | −0.936 | 1.86 | 2.22 | — | 2.22 | 22.17 |
| CrHO₂ | 0.474 H₂O₂ + 0.526 CrHO₂ → 0.105 Cr₅O₁₂ + 0.737 H₂O | 0.90 | 0.61 | −0.068 | 25.62 | 26.22 | 76.0 | 19.94 | |
| CrO_{2.4} | No reaction | — | — | — | — | — | — | — | |
| Ga | 0.6 H₂O₂ + 0.4 Ga → 0.4 GaHO₂ + 0.4 H₂O | 1.50 | 0.36 | −0.884 | 1.97 | 2.33 | — | 2.33 | 2.33 |
| GaHO₂ | No reaction | — | — | — | — | — | — | — | |
| Y | 0.333 H₂O₂ + 0.667 Y → 0.222 YH₃ + 0.222 Y₂O₃ | 0.50 | 1.09 | −1.888 | 0.92 | 2.02 | — | 2.02 | 9.99 |
| YH₃ | 0.25 YH₃ + 0.75 H₂O₂ → H₂O + 0.25 YHO₂ | 3.00 | 0.18 | −0.900 | 1.94 | 2.12 | 88.8 | 1.88 | |
| YO_{1.5} | 0.333 H₂O₂ + 0.667 YO_{1.5} → 0.667 YHO₂ + 0.167 O₂ | 0.50 | 1.09 | −0.049 | 35.55 | 36.64 | 16.6 | 6.10 | |
| YHO₂ | No reaction | — | — | — | — | — | — | — | |
| Zr | 0.667 Zr + 0.333 H₂O₂ → 0.333 ZrO₂ + 0.333 ZrH₂ | 0.50 | 1.09 | −1.599 | 1.09 | 2.18 | — | 2.18 | 4.80 |
| ZrH₂ | 0.75 H₂O₂ + 0.25 ZrH₂ → 0.25 ZrO₂ + H₂O | 3.00 | 0.18 | −0.978 | 1.78 | 1.96 | 133.2 | 2.61 | |
| ZrO₂ | No reaction | — | — | — | — | — | — | — | |
| Nb | 0.707 H₂O₂ + 0.293 Nb → 0.024 Nb₁₂O₂₉ + 0.707 H₂O | 2.41 | 0.23 | −1.051 | 1.66 | 1.88 | — | 1.88 | 1.94 |
| NbO_{2.4} | 0.091 H₂O₂ + 0.909 NbO_{2.4} → 0.091 H₂O + 0.455 Nb₂O₅ | 0.10 | 5.45 | −0.089 | 19.57 | 25.02 | 0.2 | 0.06 | |
| NbO_{2.5} | No reaction | — | — | — | — | — | — | — | |
| Mo | 0.667 H₂O₂ + 0.333 Mo → 0.667 H₂O + 0.333 MoO₂ | 2.00 | 0.27 | −0.785 | 2.22 | 2.49 | — | 2.49 | 6.94 |
| MoO₂ | 0.5 H₂O₂ + 0.5 MoO₂ → 0.5 MoO₃ + 0.5 H₂O | 1.00 | 0.55 | −0.284 | 6.13 | 6.68 | 66.6 | 4.45 | |
| MoO₃ | No reaction | — | — | — | — | — | — | — | |
| In | 0.6 H₂O₂ + 0.4 In → 0.4 In(HO)₃ | 1.50 | 0.36 | −0.800 | 2.18 | 2.54 | — | 2.54 | 2.54 |
| In(HO)₃ | No reaction | — | — | — | — | — | — | — | |
| Sn | 0.667 H₂O₂ + 0.333 Sn → 0.333 SnO₂ + 0.667 H₂O | 2.00 | 0.27 | −0.781 | 2.23 | 2.50 | — | 2.50 | 2.50 |
| SnO₂ | No reaction | — | — | — | — | — | — | — | |
| La | 0.333 H₂O₂ + 0.667 La → 0.667 LaHO | 0.50 | 1.09 | −1.868 | 0.93 | 2.03 | — | 2.03 | 6.14 |
| LaHO | 0.5 H₂O₂ + 0.5 LaHO → 0.5 La(HO)₃ | 1.00 | 0.55 | −0.687 | 2.54 | 3.08 | 133.4 | 4.11 | |
| La(HO)₃ | No reaction | — | — | — | — | — | — | — | |
| Pr | 0.333 H₂O₂ + 0.667 Pr → 0.222 PrH₃ + 0.222 Pr₂O₃ | 0.50 | 1.09 | −1.710 | 1.02 | 2.11 | — | 2.11 | 9.23 |
| PrH₃ | 0.75 H₂O₂ + 0.25 PrH₃ → 0.75 H₂O + 0.25 Pr(HO)₃ | 3.00 | 0.18 | −0.905 | 1.92 | 2.11 | 88.8 | 1.87 | |
| PrO_{1.5} | 0.6 H₂O₂ + 0.4 PrO_{1.5} → 0.4 Pr(HO)₃ + 0.3 O₂ | 1.50 | 0.36 | −0.094 | 18.53 | 18.90 | 27.8 | 5.24 | |
| Pr(HO)₃ | No reaction | — | — | — | — | — | — | — | |
| Nd | 0.333 H₂O₂ + 0.667 Nd → 0.667 NdHO | 0.50 | 1.09 | −1.787 | 0.97 | 2.07 | — | 2.07 | 6.14 |
| NdHO | 0.5 H₂O₂ + 0.5 NdHO → 0.5 Nd(HO)₃ | 1.00 | 0.55 | −0.695 | 2.51 | 3.05 | 133.4 | 4.07 | |
| Nd(HO)₃ | No reaction | — | — | — | — | — | — | — | |
| Sm | 0.333 H₂O₂ + 0.667 Sm → 0.222 Sm₂O₃ + 0.222 SmH₃ | 0.50 | 1.09 | −1.813 | 0.96 | 2.05 | — | 2.05 | 10.40 |
| SmH₃ | 0.75 H₂O₂ + 0.25 SmH₃ → 0.25 Sm(HO)₃ + 0.75 H₂O | 3.00 | 0.18 | −0.897 | 1.94 | 2.12 | 88.8 | 1.89 | |
| SmO_{1.5} | 0.6 H₂O₂ + 0.4 SmO_{1.5} → 0.4 Sm(HO)₃ + 0.3 O₂ | 1.50 | 0.36 | −0.076 | 22.92 | 23.28 | 27.8 | 6.46 | |
| Sm(HO)₃ | No reaction | — | — | — | — | — | — | — | |
| Gd | 0.667 Gd + 0.333 H₂O₂ → 0.222 GdH₃ + 0.222 Gd₂O₃ | 0.50 | 1.09 | −1.838 | 0.95 | 2.04 | — | 2.04 | 9.29 |
| GdH₃ | 0.25 GdH₃ + 0.75 H₂O₂ → 0.25 GdHO₂ + H₂O | 3.00 | 0.18 | −0.894 | 1.95 | 2.13 | 88.8 | 1.89 | |
| GdO_{1.5} | 0.667 GdO_{1.5} + 0.333 H₂O₂ → 0.667 GdHO₂ + 0.167 O₂ | 0.50 | 1.09 | −0.056 | 31.11 | 32.20 | 16.6 | 5.36 | |
| GdHO₂ | No reaction | — | — | — | — | — | — | — | |
| Dy | 0.333 H₂O₂ + 0.667 Dy → 0.222 DyH₃ + 0.222 Dy₂O₃ | 0.50 | 1.09 | −1.910 | 0.91 | 2.00 | — | 2.00 | 3.88 |
| DyH₃ | 0.75 H₂O₂ + 0.25 DyH₃ → 1.125 H₂O + 0.125 Dy₂O₃ | 3.00 | 0.18 | −0.902 | 1.93 | 2.11 | 88.8 | 1.88 | |
| DyO_{1.5} | No reaction | — | — | — | — | — | — | — | |
| Er | 0.333 H₂O₂ + 0.667 Er → 0.222 ErH₃ + 0.222 Er₂O₃ | 0.50 | 1.09 | −1.938 | 0.90 | 1.99 | — | 1.99 | 10.34 |
| ErH₃ | 0.75 H₂O₂ + 0.25 ErH₃ → H₂O + 0.25 ErHO₂ | 3.00 | 0.18 | −0.911 | 1.91 | 2.09 | 88.8 | 1.86 | |
| ErO_{1.5} | 0.333 H₂O₂ + 0.667 ErO_{1.5} → 0.667 ErHO₂ + 0.167 O₂ | 0.50 | 1.09 | −0.046 | 37.87 | 38.96 | 16.6 | 6.48 | |
| ErHO₂ | No reaction | — | — | — | — | — | — | — | |
| Ta | 0.444 Ta + 0.556 H₂O₂ → 0.222 Ta₂O₅ + 0.556 H₂ | 1.25 | 0.44 | −1.156 | 1.51 | 1.94 | — | 1.94 | 1.94 |
| TaO_{2.5} | No reaction | — | — | — | — | — | — | — | |
| W | 0.75 H₂O₂ + 0.25 W → 0.25 WO₃ + 0.75 H₂O | 3.00 | 0.18 | −0.745 | 2.34 | 2.52 | — | 2.52 | 2.52 |
| WO₃ | No reaction | — | — | — | — | — | — | — | |

According to Table 5, some M/MOₓ react with H₂O₂ through one step, such as Si/SiO₂ or Sn/SnO₂, in which cases when M is oxidized to MOₓ, MOₓ may not further react with H₂O₂. A general reaction between such a M/MOₓ and H₂O₂ can be described as: aM+bH₂O₂→cMOₓ₊ other products (e.g. H₂O or H₂), where 0<a<1, 0<b<1, and 0<c<1. Still referring to Table 5, some other M/MOₓ react with H₂O₂ through multiple steps, such as Al/AlOₓ or Ti/TiOₓ, in which cases when M first reacts with H₂O₂, the intermediate product(s) may further react with H₂O₂ until M is fully oxidized to an oxidation state where MOₓ no longer reacts with H₂O₂.

Table 6 provides a summary of the information of M/MOₓ in Table 5 in an order from the lowest total of the adjusted sum of penalty points to the highest total of the adjusted sum of penalty points. Table 6 also provides information of whether the reaction between M/MOₓ and H₂O₂ is a one-step or multiple-step reaction.

TABLE 6
Summary of M/MOₓ in Table 5 based on a total
of the adjusted sum of penalty points and the reaction step(s) between
M/MOₓ and H₂O₂.

| M in | | One-step | Multiple-step |
|---|---|---|---|
| M/MOₓ | ΣPP″ | reaction | reaction |
| Nb | 1.94 | — | Yes |
| Ta | 1.94 | Yes | — |
| Si | 2.00 | Yes | — |
| Ga | 2.33 | Yes | — |
| Sn | 2.50 | Yes | — |
| W | 2.52 | Yes | — |
| In | 2.54 | Yes | — |
| Dy | 3.88 | — | Yes |
| Ce | 4.21 | — | Yes |
| (reference) | | | |
| Zr | 4.80 | — | Yes |
| Ti | 5.62 | — | Yes |
| La | 6.14 | — | Yes |
| Nd | 6.14 | — | Yes |
| Mo | 6.94 | — | Yes |
| V | 8.26 | — | Yes |
| Pr | 9.23 | — | Yes |
| Gd | 9.29 | — | Yes |
| Y | 9.99 | — | Yes |
| Er | 10.34 | — | Yes |
| Sm | 10.40 | — | Yes |
| Mn | 11.38 | — | Yes |

According to Table 6, when M=Nb, Ta, Si, Ga, Sn, W, In, or Dy, M/MOₓ may react with H₂O₂ more favorably than Ce/CeOₓ. Further, when M=Zr, Ti, La, Nd, Mo, V, Pr, Gd, Y, Er, and Sm, M/MOₓ reacts with H₂O₂ less favorably than Ce/CeOₓ but more favorably than Mn/MnOₓ.

For a M/MOₓ to be comparably more effective than Ce/CeOₓ and/or Mn/MnOₓ as radical scavengers for fuel cells, M/MOₓ needs not only reacting with H₂O₂ more favorably than Ce/CeOₓ and/or Mn/MnOₓ, but needs to be more stable (e.g. less soluble) than Ce/CeOₓ and/or Mn/MnOₓ in a fuel cell acidic environment.

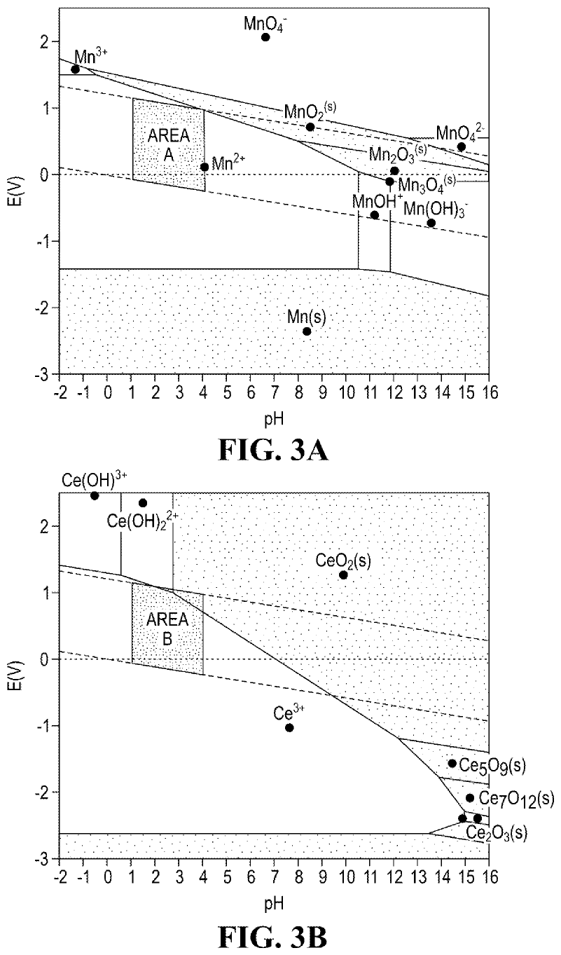

FIG. 3A depicts a Pourbaix diagram of Ce showing possible thermodynamically stable phases of Ce in an aqueous electrochemical environment. The Pourbaix diagram is generated from materialsproject.org using pourbaixdiagram app. As shown in FIG. 3A, Ce appears to be stable as Ce³⁺ ions when a voltage potential E(V) applied to the aqueous electrochemical environment is between 0 V to 1 V and when a pH value of the aqueous electrochemical environment is between 1 and 4, indicated by an area A. The conditions in the area A may represent the fuel cell acidic environment in a fuel cell. Therefore, FIG. 3A suggests that when Ce/CeOₓ is used as a radical scavenger for fuel cells, Ce/CeOₓ may exist as Ce³⁺ ions in the fuel cell acidic environment. Since Ce³⁺ ions can migrate from one location to another, Ce/CeOₓ may not be ideal to act as a radical scavenger for fuel cells.

FIG. 3B depicts a Pourbaix diagram of Mn showing possible thermodynamically stable phases of Mn in an aqueous electrochemical environment. The Pourbaix diagram is generated from materialsproject.org using pourbaixdiagram app. As shown in FIG. 3B, Mn appears to be stable as Mn²⁺ ions when a voltage potential E(V) applied to the aqueous electrochemical environment is between 0 V to 1 V and when a pH value of the aqueous electrochemical environment is between 1 and 4, indicated by an area B. The conditions in the area B may represent the fuel cell acidic environment in a fuel cell. Therefore, FIG. 3B suggests that when Mn/MnOₓ is used as a radical scavenger for fuel cells, Mn/MnOₓ may exist as Mn²⁺ ions in the fuel cell acidic environment. Since Mn²⁺ ions can migrate from one location to another, Mn/MnOₓ may not be ideal to act as a radical scavenger for fuel cells.

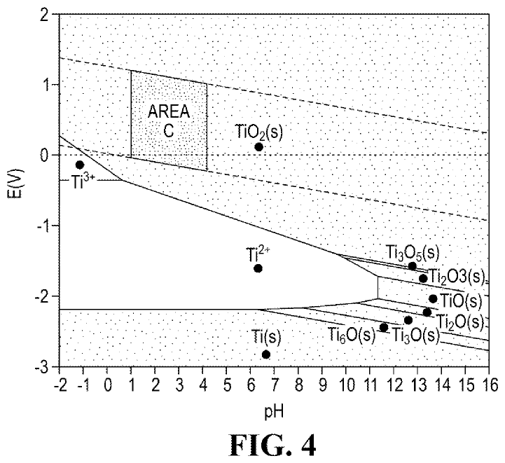

In order to evaluate possible thermodynamically stable phases of the M/MOₓ in Table 6, a Pourbaix diagram of each metal element can be generated from materialsproject.org using pourbaixdiagram app. For example, FIG. 4 depicts a Pourbaix diagram of Ti showing possible thermodynamically stable phases of Ti in an aqueous electrochemical environment. As shown in FIG. 4, Ti appears to be stable as TiO₂ when a voltage potential E(V) applied to the aqueous electrochemical environment is between 0 V to 1 V and when a pH value of the aqueous electrochemical environment is between 1 and 4, indicated by an area C. The conditions in the area C may represent the fuel cell acidic environment in a fuel cell. Therefore, FIG. 4 suggests that when Ti/TiOₓ is used as a radical scavenger for fuel cells, Ti/TiOₓ may exist as TiO₂ but rather be ionized in the fuel cell acidic environment. Therefore, Ti/TiOₓ may be a comparable radical scavenger for fuel cells.

Table 7 provides a summary of possible thermodynamically stable phases of the M/MOₓ in Table 6 when present in a fuel cell acidic environment. Such information may be obtained from a Pourbaix diagram of each metal element which can be generated from materialsproject.org using pourbaixdiagram app. The fuel cell acidic environment may correspond to an area where a voltage potential E(V) is between 0 V to 1 V and where a pH value is between 1 and 4 in the Pourbaix diagram of each metal element. Table 7 also provides the M/MOₓ in an order from the lowest total of the adjusted sum of penalty points to the highest total of the adjust sum of penalty points as described in Table 6.

TABLE 7
Summary of possible thermodynamically stable
phases of the M/MOₓ illustrated in Table 6 when
present in a fuel cell acidic environment.

| | | Possible thermodynamically |
|---|---|---|
| M in | ΣPP″ | stable phases of the M/MOₓ |
| M/MOₓ | (M/MOₓ) | in a fuel cell acidicenvironment |
| Nb | 1.94 | Nb₂O₅ |
| Ta | 1.94 | Ta₂O₅ |
| Si | 2.00 | SiO₂, H₄SiO₄, H₂SiO₃ |
| Ga | 2.33 | Ga₂O₃ |
| Sn | 2.50 | SnO₂ |
| W | 2.52 | WO₃ |
| In | 2.54 | In³⁺ |
| Dy | 3.88 | Dy³⁺ |
| Ce | 4.21 | Ce³⁺ |
| (reference) | | |
| Zr | 4.80 | ZrO₂ |
| Ti | 5.62 | TiO₂ |
| La | 6.14 | La³⁺ |
| Nd | 6.14 | Nd³⁺ |
| Mo | 6.94 | MoO₃ |
| V | 8.26 | VO²⁺ |
| Pr | 9.23 | Pr³⁺ |
| Gd | 9.29 | Gd³⁺ |
| Y | 9.99 | Y³⁺ |
| Er | 10.34 | Er³⁺ |
| Sm | 10.40 | Sm³⁺ |
| Mn | 11.38 | Mn²⁺ |

Table 7 suggests that some M/MOₓ may be stable as ions in the fuel cell acidic environment, for example, when M=In, Dy, La, Nd, Pr, Gd, Y, Er and Sm. Among these metal elements, however, In/InOₓ and Dy/DyOₓ appear to react with H₂O₂ more favorably than Ce/CeOₓ. Table 7 further suggests that some other M/MOₓ may be passivated to metal oxides in the fuel cell acidic environment, for example, when M=Nb, Ta, Si, Ga, Sn, W, Zr, Ti, and Mo. These metal oxides do not react with H₂O₂, and thus stable in the fuel cell acidic environment, making these M/MOₓ suitable to be used as radical scavengers for fuel cells. Furthermore, among these M/MOₓ, Nb/NbOₓ, Ta/TaOₓ, Si/SiOₓ, Ga/GaOₓ, Sn/SnOₓ, and W/WOₓ appear to react with H₂O₂ more favorably than Ce/CeOₓ; Zr/ZrOₓ and Ti/TiOₓ appear to react with H₂O₂ less favorably than Ce/CeOₓ but more favorably than Mn/MnOₓ.

In view of Tables 6 and 7, M/MOₓ may be categorized into several groups in terms of the following factors: (1) the reactivity of M/MOₓ against H₂O₂; (2) reaction step(s) when M/MOₓ reacts with H₂O₂ (i.e. a one-step or multiple-step reaction); (3) possible thermodynamically stable phases of M in a fuel cell acidic environment.

Table 8 shows a summary of M/MOₓ in Tables 6 and 7 categorized in six groups. Particularly, Group I may include Nb/NbOₓ, which appears to react with H₂O₂ more favorably than Ce/CeOₓ (i.e., also more favorably than Mn/MnOₓ) and appears to be stable as metal oxides in a fuel cell acidic environment. Group II may include M/MOₓ with M=Ta, Si, Ga, Sn, W, which appear to react with H₂O₂ more favorably than Ce/CeOₓ (i.e., also more favorably than Mn/MnOₓ) and appear to be stable as metal oxides in a fuel cell acidic environment. The M/MOₓ in Group II, however, may react with H₂O₂ less favorably than Nb/NbOₓ in Group I. Group III may include Dy/DyOₓ, which appears to react with H₂O₂ more favorably than Ce/CeOₓ (i.e., also more favorably than Mn/MnOₓ) but appears to be present as metal ions (i.e. Dy³⁺) in a fuel cell acidic environment. Group IV may include In/InOₓ, which appears to react with H₂O₂ more favorably than Ce/CeOₓ (i.e., also more favorably than Mn/MnOₓ) but appears to be present as metal ions (i.e. In³⁺) in a fuel cell acidic environment. Group V may include M/MOₓ with M=Zr, Ti, Mo, which appear to react with H₂O₂ more favorably than Mn/MnOₓ but less favorably than Ce/CeOₓ and appear to be stable as metal oxides in a fuel cell acidic environment. Lastly, Group VI may include M/MOₓ with M=La, Nd, V, Pr, Gd, Y, Er, Sm, which appear to react with H₂O₂ more favorably than Mn/MnOₓ but less favorably than Ce/CeOₓ and appear to be present as metal ions in a fuel cell acidic environment. As such, each of the M/MOₓ in Table 8 may be used as radical scavengers for fuel cells due to their comparability to Ce/CeOₓ and/or Mn/MnOₓ in terms of their reactivities against H₂O₂ and their stability in a fuel cell acidic environment.

TABLE 8
Summary of the M/MOₓ categorized in six groups.

| Group | Classification | M in M/MOₓ |
|---|---|---|
| I | ΣPP″ (M/MOₓ) < 4.21 (i.e. Ce/CeOₓ) | Nb |
| | Multiple-step reaction | |
| | Stable as metal oxides in a fuel cell acidic | |
| | environment | |
| II | ΣPP″ (M/MOₓ) < 4.21 (i.e. Ce/CeOₓ) | Ta, Si, Ga, Sn, W |
| | One-step reaction | |
| | Stable as metal oxides in a fuel cell acidic | |
| | environment | |
| III | ΣPP″ (M/MOₓ) < 4.21 (i.e. Ce/CeOₓ) | Dy |
| | Multiple-step reaction | |
| | Soluble as metals ions in a fuel cell acidic | |
| | environment | |
| IV | ΣPP″ (M/MOₓ) < 4.21 (i.e. Ce/CeOₓ) | In |
| | One-step reaction | |
| | Soluble as metals ions in a fuel cell acidic | |
| | environment | |
| V | ΣPP″ (M/MOₓ) < 11.38 (i.e. Mn/MnOₓ) | Zr, Ti, Mo |
| | Multiple-step reaction | |
| | Stable as metal oxides in a fuel cell acidic | |
| | environment | |
| VI | ΣPP″ (M/MOₓ) < 11.38 (i.e. Mn/MnOₓ) | La, Nd, V, Pr, Gd, |
| | Multiple-step reaction | Y, Er, Sm |
| | Soluble as metals ions in a fuel cell acidic | |
| | environment | |

Next, the data-driven materials screening method is used to evaluate Ce—Mn mixtures as radical scavengers for fuel cells. The Ce—Mn mixtures may have different ratios of Ce and Mn. Some of these Ce—Mn mixtures may include Ce_{0.25}Mn_{0.75}, Ce_{0.5}Mn_{0.5}, and Ce_{0.75}Mn_{0.25}. Table 9 provides information of a total of the adjusted sum of penalty points for all Ce—Mn chain reactions, i.e. ΣPP″(Ce—Mn). The total of the adjusted sum of penalty points can be calculated as discussed above, for example, in Table 5. Although Table 9 shows radical scavengers having three different ratios of Ce and Mn, that is, 25% Ce and 75% Mn, 50% Ce and 50% Mn, and 75% Ce and 25% Mn, Ce—Mn mixtures having other ratios of Ce and Mn may also be analyzed using the data-driven materials screening method.

TABLE 9
Information of a total of the adjusted sum of penalty
points for all Ce—Mn chain reactions of Ce—Mn
mixtures having different ratios of Ce and Mn.

| | ΣPP″ |
|---|---|
| Ce—Mn mixture | (Ce—Mn) |
| Mn/MnOₓ | 11.38 |
| Ce_{0.25}Mn_{0.75} | 9.38 |
| Ce_{0.5}Mn_{0.5} | 11.39 |
| Ce_{0.75}Mn_{0.25} | 4.23 |
| Ce/CeOₓ | 4.21 |
| (reference) | |

As shown in Table 9, as the ratio of Ce increases, the reactivity of Ce—Mn mixtures may also increase. This is consistent with the results in Tables 1 and 2, where Ce/CeOₓ is shown to react with H₂O₂ more favorably than Mn/MnOₓ. Particularly, when the Ce—Mn mixture includes 25% Ce and 75% Mn, i.e., Ce_{0.25}Mn_{0.75}, the Ce—Mn mixture appears to be comparably more effective than Mn/MnOₓ as a radical scavenger.

Next, the data-driven materials screening method is used to evaluate Ce—M—O compounds which may be suitable to be used as radical scavengers for fuel cells, where M may be Nb, Ta, Si, Ga, Sn, W, Dy, In, Zr, Ti, or Mo. Some of the Ce—M—O compounds may include CeNbO₄, CeTaO₄, CeTa₇O₁₉, Ce₂Si₂O₇, Ce₂Zr₂O₇, Ce₂TiO₅, CeNb₃O₉, CeTa₃O₉, Ce₃TaO₇, Ce₂WO₆, Ce₉DyO₂₀, CeZr₁₁O₂₄, Ce₇ZrO₁₆, CeZr₇O₁₆, Ce₂Ti₂O₇, and Ce₂Mo₄O₁₅. Among these Ce—M—O compounds, CeNbO₄, CeTaO₄, CeTa₇O₁₉, Ce₂Si₂O₇, Ce₂Zr₂O₇, and Ce₂TiO₅ may be stable at temperature equals 0 K and above; the other Ce—M—O compounds, CeNb₃O₉, CeTa₃O₉, Ce₃TaO₇, Ce₂WO₆, Ce₉DyO₂₀, CeZr₁₁O₂₄, Ce₇ZrO₁₆, CeZr₇O₁₆, Ce₂Ti₂O₇, Ce₂Mo₄O₁₅, may become stable at room temperature. Furthermore, among the Ce—M—O compounds, CeTa₇O₁₉, Ce₉DyO₂₀, CeZr₁₁O₂₄, Ce₇ZrO₁₆, and CeZr₇O₁₆ may not react with H₂O₂. As such, the data-driven materials screening method is used to evaluate the remaining Ce—M—O compounds that may react with H₂O₂.

Table 11 provides information of the reaction between each Ce—M—O compound and H₂O₂. Particularly, Table 11 provides a reaction equation of the most stable decomposition reaction between each Ce—M—O compound and H₂O₂. For each Ce—M—O compound, a first penalty point based on a molar fraction between H₂O₂ and each Ce—M—O compound and a second penalty point based on a reaction enthalpy of each reaction are calculated. The calculation method is analogous to those described in Tables 2 to 5. Table 11 further provides a sum of the penalty points, i.e., ΣPP(Ce—M—O). The reaction between Ce and H₂O₂ in Table 1 is used herein as a reference. Also, as shown in Table 1, Σ′PP(Ce/CeOₓ) is about 4.21; as shown in Table 2, ΣPP(Mn/MnOₓ) is about 11.38.

Table 11 also provides a molecular weight (MW) of each Ce—M—O compound. Table 11 further provides a sum of the penalty points of each Ce—M—O compound per MW, i.e., ΣPP(Ce—M—O) per MW. To easily compare the reactivity of each Ce—M—O compound against H₂O₂ with Ce and/or Mn, Table 11 provides a sum of the penalty points of Ce per its MW (about 140.12 g/mol), i.e., ΣPP(Ce) per MW=2.00/140.12, which is about 14.3 mg; and a sum of the penalty points of Mn per its MW (about 54.94), i.e., ΣPP(Mn) per MW=2.56/54.94, which is about 46.7 mg.

TABLE 11
Information of the reaction between each Ce—M—O compound and H₂O₂.

| | Equation of the most stable | | | ΣPP |
|---|---|---|---|---|
| | decomposition reaction between | ΣPP | MW | (Ce—M—O) |
| Ce—M—O | Ce—M—O and H₂O₂ | (Ce—M—O) | (g/mol) | per MW (mg) |
| Ce | See Table 1 | 2.00 | 140.12 | 14.3 |
| (reference) | | | | |
| Mn | See Table 2 | 2.56 | 54.94 | 46.7 |
| CeNbO₄ | 0.333 H₂O₂ + 0.667 | 9.12 | 297.02 | 30.7 |
| | CeNbO₄ → 0.667 CeO₂ + | | | |
| | 0.333 H₂O + 0.333 Nb₂O₅ | | | |
| CeTaO₄ | 0.333 H₂O₂ + 0.667 | 9.51 | 385.06 | 24.7 |
| | CeTaO₄ → 0.667 CeO₂ + | | | |
| | 0.333 H₂O + 0.333 Ta₂O₅ | | | |
| Ce₂Si₂O₇ | 0.5 Ce₂Si₂O₇ + 0.5 H₂O₂ → | 6.62 | 448.40 | 14.8 |
| | CeO₂ + | | | |
| | 0.5 H₂O + SiO₂ | | | |
| Ce₂Zr₂O₇ | 0.5 H₂O₂ + 0.5 Ce₂Zr₂O₇ → | 5.96 | 574.68 | 10.4 |
| | CeO₂ + 0.5 H₂O + ZrO₂ | | | |
| Ce₂TiO₅ | 0.5 Ce₂TiO₅ + 0.5 H₂O₂ → | 5.31 | 408.10 | 13.0 |
| | 0.5 H₂O + 0.5 TiO₂ + CeO₂ | | | |
| CeNb₃O₉ | 0.333 H₂O₂ + 0.667 CeNb₃O₉ → | 14.70 | 562.83 | 26.1 |
| | 0.667 CeO₂ + 0.333 H₂O + Nb₂O₅ | | | |
| CeTa₃O₉ | 0.333 H₂O₂ + 0.667 CeTa₃O₉ → | 14.92 | 826.95 | 18.0 |
| | 0.667 CeO₂ + 0.333 H₂O + Ta₂O₅ | | | |
| Ce₃TaO₇ | 0.6 H₂O₂ + 0.4 Ce₃TaO₇ → 1.2 | 4.83 | 713.29 | 6.8 |
| | CeO₂ + 0.6 H2O + 0.2 Ta₂O₅ | | | |
| Ce₂WO₆ | 0.5 H₂O₂ + 0.5 Ce₂WO₆ → | 7.49 | 560.07 | 13.4 |
| | CeO₂ + 0.5 WO₃ + 0.5 H₂O | | | |
| Ce₂Ti₂O₇ | 0.5 Ce2Ti2O7 + 0.5 H₂O₂ → 0.5 | 6.16 | 487.96 | 12.6 |
| | H₂O + TiO₂ + CeO₂ | | | |
| Ce₂Mo₄O₁₅ | 0.5 H₂O₂ + 0.5 Ce2Mo₄O₁₅ → | 18.50 | 903.98 | 20.5 |
| | CeO₂ + 2 MoO₃ + 0.5 H₂O | | | |

Table 12 provides a summary of the information illustrated in Table 11 in an order from the lowest ΣPP(Ce—M—O) per MW to the highest ΣPP(Ce—M—O) per MW.

TABLE 12
Summary of the information illustrated in Table 11.

| | ΣPP |
|---|---|
| | (Ce—M—O) |
| Compound | per MW (mg) |
| Ce₃TaO₇ | 6.8 |
| Ce₂Zr₂O₇ | 10.4 |
| Ce₂Ti₂O₇ | 12.6 |
| Ce₂TiO₅ | 13.0 |
| Ce₂WO₆ | 13.4 |
| Ce | 14.3 |
| (reference) | |
| Ce₂Si₂O₇ | 14.8 |
| CeTa₃O₉ | 18.0 |
| Ce₂Mo₄O₁₅ | 20.5 |
| CeTaO₄ | 24.7 |
| CeNb₃O₉ | 26.1 |
| CeNbO₄ | 30.7 |
| Mn | 46.7 |

According to Table 12, Ce—M—O compounds such as Ce₃TaO₇, Ce₂Zr₂O₇, Ce₂Ti₂O₇, Ce₂TiO₅, and Ce₂WO₆ may be superior radical scavengers to Ce. Further, although the reactivity of each Ce—M—O compound such as Ce₂Si₂O₇, CeTa₃O₉, Ce₂Mo₄O₁₅, CeTaO₄, CeNb₃O₉, and CeNbO₄ against H₂O₂ appears to be lower than that of Ce against H₂O₂, each of these Ce—M—O compounds appears to react with H₂O₂ more favorably than Mn. Taken together, all the Ce—M—O compounds, i.e., Ce₃TaO₇, Ce₂Zr₂O₇, Ce₂Ti₂O₇, Ce₂TiO₅, Ce₂WO₆, Ce₂Si₂O₇, CeTa₃O₉, Ce₂Mo₄O₁₅, CeTaO₄, CeNb₃O₉, and CeNbO₄, appear to be comparably effective to Ce and/or Mn as radical scavengers for fuel cells.

To synthesize a M/MOₓ radical scavenger material, various metal containing precursors may be annealed with a stoichiometric amount in slightly reducing heat treatment condition using N₂, Ar, or H₂ mixture gas, etc., where a heat treatment temperature may be in a range of 150 to 1,000° C. to yield a desired chemistry. A heat treatment time may be in a range of 30 seconds to 24 hours. Depending on the oxidation state, it may be possible to carry out heat treatment in air.

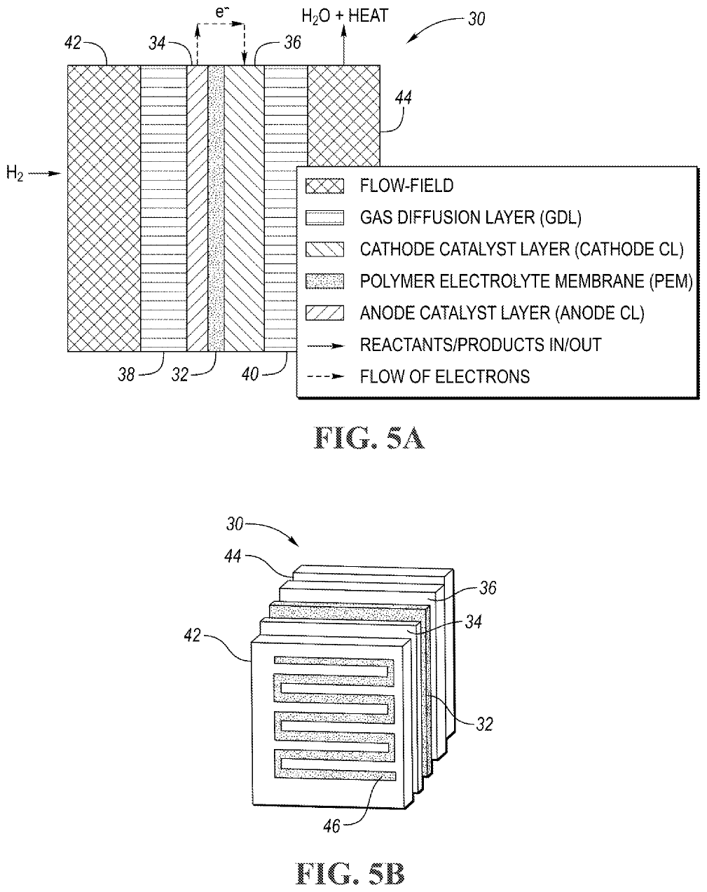

FIG. 5A is a schematic cross-sectional view of a fuel cell. FIG. 5B is a schematic perspective view of components of the fuel cell shown in FIG. 5A. FIG. 5A also generally depicts the reactants and products of the operation of the fuel cell. The fuel cell 30 may be a PEM fuel cell. As shown in FIG. 5A, the fuel cell 30 includes a PEM 32, a first catalyst layer 34 and a second catalyst layer 36. The PEM 32 is situated between the first and second catalyst layers, 34 and 36. The fuel cell 30 further includes a first GDL 38 surrounding the first catalyst layer 34, and a second GDL 40 surrounding the second catalyst layer 36. The PEM 32, the first and second catalyst layers 34 and 36, and the first and second GDLs form a membrane electrode assembly (MEA). The MEA is further surrounded by a first and second bipolar plates (i.e. flow-field plates), 42 and 44. The first and second bipolar plates, 42 and 44, are positioned at opposite ends of the fuel cell 30 and surround the first and second GDLs, 38 and 40, respectively. The first and second bipolar plates, 42 and 44, may provide structural support and conductivity, and may assist in supplying fuel and oxidants (air) in the fuel cell 30. The first and second bipolar plates, 42 and 44, may also assist in removal of reaction products or byproducts from the fuel cell 30. As shown in FIG. 5B, the first bipolar plate 42 includes a flow passage 46. The second bipolar plate 44 also includes a flow passage (not shown). The flow passages are configured to assist in supplying fuel and/or removing byproducts in the fuel cell 13.

During the operation of the fuel cell 30, H₂O₂ may be generated in a fuel cell acidic environment. Decomposition of H₂O₂ may lead to the generation of radical species in the fuel cell acidic environment. The radical species may include •OH, •H, and •OOH. The radical species may diffuse into the PEM 32 and other fuel cell components. To prevent fuel cell components from attack by the radical species, peroxide decomposition radical scavenger materials may be incorporated into the fuel cell components.

In one embodiment, the radical scavenger is M/MOₓ (1≤x≤3), where M may be Nb, Ta, Si, Ga, Sn, W, Dy, In, Zr, Ti, Mo, La, Nd, V, Pr, Gd, Y, Er, or Sm. In another embodiment, the radical scavenger is M/MOₓ (1≤x≤3) mixed with at least one of Ce/CeOₓ (0.5≤x≤4) and Mn/MnOₓ (0.5≤x≤4). In yet another embodiment, the radical scavenger may be a Ce—Mn mixture. Some examples of the Ce—Mn mixture may include Ce_{0.25}Mn_{0.75}, Ce_{0.5}Mn_{0.5}, or Ce_{0.75}Mn_{0.25}. In still yet another embodiment, the radical scavenger may be a Ce—M—O compound, where M is a metal element other than Ce. For example, M may be Nb, Ta, Si, Ga, Sn, W, Dy, In, Zr, Ti, or Mo. Some examples of the Ce—M—O compound may include Ce₃TaO₇, Ce₂Zr₂O₇, Ce₂Ti₂O₇, Ce₂TiO₅, Ce₂WO₆, Ce₂Si₂O₇, CeTa₃O₉, Ce₂Mo₄O₁₅, CeTaO₄, CeNb₃O₉, and CeNbO₄. In some other embodiments, the radical scavenger may be any of the combination of M/MOₓ (1≤x≤3, M=Nb, Ta, Si, Ga, Sn, W, Dy, In, Zr, Ti, Mo, La, Nd, V, Pr, Gd, Y, Er, or Sm), Ce/CeOₓ (0.5≤x≤4), Mn/MnOₓ (0.5≤x≤4), a Ce—Mn mixture, or a Ce—M—O compound (M=Ta, Zr, Ti, W, Si, Mo, or Nb).

Referring to FIGS. 5A and 5B, to prevent the PEM 32 from attack by radical species, a radical scavenger may be incorporated into the PEM 32. In one embodiment, the radical scavenger is M/MOₓ (1≤x≤3), where M may be Nb, Ta, Si, Ga, Sn, W, Dy, In, Zr, Ti, Mo, La, Nd, V, Pr, Gd, Y, Er, or Sm. In another embodiment, the radical scavenger is M/MOₓ (1≤x≤3) mixed with at least one of Ce/CeOₓ (0.5≤x≤4) and Mn/MnOₓ (0.5≤x≤4). In yet another embodiment, the radical scavenger may be a Ce—Mn mixture. Some examples of the Ce—Mn mixture may include Ce_{0.25}Mn_{0.75}, Ce_{0.5}Mn_{0.5}, or Ce_{0.75}Mn_{0.25}. In still yet another embodiment, the radical scavenger may be a Ce—M—O compound, where M is a metal element other than Ce. For example, M may be Nb, Ta, Si, Ga, Sn, W, Dy, In, Zr, Ti, or Mo. Some examples of the Ce—M—O compound may include Ce₃TaO₇, Ce₂Zr₂O₇, Ce₂Ti₂O₇, Ce₂TiO₅, Ce₂WO₆, Ce₂Si₂O₇, CeTa₃O₉, Ce₂Mo₄O₁₅, CeTaO₄, CeNb₃O₉, and CeNbO₄. In some other embodiments, the radical scavenger may be any of the combination of M/MOₓ (1≤x≤3, M=Nb, Ta, Si, Ga, Sn, W, Dy, In, Zr, Ti, Mo, La, Nd, V, Pr, Gd, Y, Er, or Sm), Ce/CeOₓ (0.5≤x≤4), Mn/MnOₓ (0.5≤x≤4), a Ce—Mn mixture, or a Ce—M—O compound (M=Ta, Zr, Ti, W, Si, Mo, or Nb).

Apart from the PEM 32, radical scavengers may also be incorporated into other fuel cell components which are susceptible to radical attacks. These fuel cell components may be the first and second catalyst layers 34 and 36, or the first and second GDLs 38 and 40. In some embodiments, a loading level of radical scavengers onto a fuel cell component may be in a range of 0.1 to 200 μg cm².

The radical scavengers M/MOₓ (1≤x≤3, M=Nb, Ta, Si, Ga, Sn, W, Dy, In, Zr, Ti, Mo, La, Nd, V, Pr, Gd, Y, Er, or Sm) discussed in the present disclosure may each act as a radical scavenger system that reacts with H₂O₂ in a reaction environment (e.g. a fuel cell acidic environment), thereby scavenging radicals (e.g. •OH, •H, and •OOH) in the reaction environment. In some embodiments, MOₓ, a reactive intermediate oxide, may react with H₂O₂ until M is fully oxidized to an oxidation state where MOₓ no longer reacts with H₂O₂ in the reaction environment.

Now, a method of incorporating peroxide decomposition radical scavenger materials into a fuel cell component will be described. The fuel cell component may be a PEM, a catalyst layer, and/or a GDL. A loading level of radical scavengers onto the fuel cell component may be in a range of, for example, 0.1 to 200 μg cm⁻². The loading level of radical scavengers may be based on the weight of the metal element(s) in the radical scavengers, not the metal oxide derivatives.

In one embodiment, a metal element material (M) may be added into the fuel cell component. The metal element material may not be oxidized before adding into the fuel cell component. The metal element material may be Nb, Ta, Si, Ga, Sn, W, Dy, In, Zr, Ti, Mo, La, Nd, V, Pr, Gd, Y, Er, or Sm. A reactive intermediate oxide of the metal element material (MOₓ, 1≤x≤3) may then be added into the fuel cell component. In some embodiments, M/MOₓ may be mixed with at least one of Ce/CeOₓ (0.5≤x≤4) and Mn/MnOₓ (0.5≤x≤4). In some other embodiments, M/MOₓ may be mixed with a Ce—Mn mixture. The Ce—Mn mixture may be Ce_{0.25}Mn_{0.75}, Ce_{0.5}Mn_{0.5}, or Ce_{0.75}Mn_{0.25}. In yet some other embodiments, M/MOₓ may be mixed with a Ce—M—O compound. The Ce—M—O compound may be Ce₃TaO₇, Ce₂Zr₂O₇, Ce₂Ti₂O₇, Ce₂TiO₅, Ce₂WO₆, Ce₂Si₂O₇, CeTa₃O₉, Ce₂Mo₄O₁₅, CeTaO₄, CeNb₃O₉, and CeNbO₄.

In another embodiment, to incorporate peroxide decomposition radical scavenger materials into a fuel cell component, a Ce—Mn mixture may be added into the fuel cell component. The Ce—Mn mixture may be Ce_{0.25}Mn_{0.75}, Ce_{0.5}Mn_{0.5}, or Ce_{0.75}Mn_{0.25}. In some embodiments, the Ce—Mn mixture may be mixed with M/MOₓ (1≤x≤3, M=Nb, Ta, Si, Ga, Sn, W, Dy, In, Zr, Ti, Mo, La, Nd, V, Pr, Gd, Y, Er, or Sm). In some other embodiments, the Ce—Mn mixture may be mixed with at least one of Ce/CeOₓ (0.5≤x≤4) and Mn/MnOₓ (0.5≤x≤4). In yet some other embodiments, the Ce—Mn mixture may be mixed with a Ce—M—O compound. The Ce—M—O compound may be Ce₃TaO₇, Ce₂Zr₂O₇, Ce₂Ti₂O₇, Ce₂TiO₅, Ce₂WO₆, Ce₂Si₂O₇, CeTa₃O₉, Ce₂Mo₄O₁₅, CeTaO₄, CeNb₃O₉, and CeNbO₄.

In yet another embodiment, to incorporate peroxide decomposition radical scavenger materials into a fuel cell component, a Ce—M—O compound may be added into the fuel cell component. M is a metal element other than Ce. M may be Nb, Ta, Si, Ga, Sn, W, Dy, In, Zr, Ti, or Mo. The Ce—M—O compound may be Ce₃TaO₇, Ce₂Zr₂O₇, Ce₂Ti₂O₇, Ce₂TiO₅, Ce₂WO₆, Ce₂Si₂O₇, CeTa₃O₉, Ce₂Mo₄O₁₅, CeTaO₄, CeNb₃O₉, and CeNbO₄. In some embodiments, the Ce—M—O compound may be mixed with at least one of M/MOₓ (1≤x≤3, M=Nb, Ta, Si, Ga, Sn, W, Dy, In, Zr, Ti, Mo, La, Nd, V, Pr, Gd, Y, Er, or Sm). In some other embodiments, the Ce—M—O compound may be mixed with at least one of Ce/CeOₓ (0.5≤x≤4) and Mn/MnOₓ (0.5≤x≤4). In yet some other embodiments, the Ce—M—O compound may be mixed with a Ce—Mn mixture. The Ce—Mn mixture may be Ce_{0.25}Mn_{0.75}, Ce_{0.5}Mn_{0.5}, or Ce_{0.75}Mn_{0.25}.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A fuel cell proton exchange membrane (PEM) comprising:
a peroxide decomposition radical scavenger material, where the peroxide decomposition radical scavenger material is M/MOₓ (1≤x≤3), and M is Nb, Ta, Si, Ga, Sn, W, Dy, In, Zr, Ti, Mo, La, Nd, V, Pr Gd, Y, Er, Sm, or a combination thereof, the peroxide decomposition radical scavenger material is mixed with a Ce—Mn mixture of Ce_{0.25}Mn_{0.75}, Ce_{0.5}Mn_{0.5}, Ce_{0.75}Mn_{0.25}, or a combination thereof.

2. (canceled)

3. The fuel cell PEM of claim 1, wherein M is Ta, W, Dy, Mo, Nd, V, Er, or Sm.

4. The fuel cell PEM of claim 1, wherein a loading level of the peroxide decomposition radical scavenger material onto the fuel cell PEM is in a range of 0.1 to 200 μg cm⁻².

5. (canceled)

6. (canceled)

7. A fuel cell proton exchange membrane (PEM) comprising:
a peroxide decomposition radical scavenger material, where the peroxide decomposition radical scavenger material is Ce₃TaO₇, Ce₂Zr₂O₇, Ce₂Ti₂O₇, Ce₂TiO₅, Ce₂WO₆, Ce₂Si₂O₇, CeTa₃O₉, Ce₂Mo₄O₁₅, CeTaO₄, CeNb₃O₉, and CeNbO₄.

8. (canceled)

9. (canceled)

10. The fuel cell PEM of claim 7, wherein a loading level of the peroxide decomposition radical scavenger material onto the fuel cell PEM is in a range of 0.1 to 200 μg cm⁻².

11. (canceled)

12. A fuel cell comprising:
a membrane electrode assembly (MEA), the MEA including:
catalyst layers;
a polymer electrolyte membrane (PEM) situated between the catalyst layers, the PEM having a peroxide decomposition radical scavenger material, the peroxide decomposition radical scavenger material is Ce₃TaO₇, Ce₂Zr₂O₇, Ce₂Ti₂O₇, Ce₂TiO₅, Ce₂WO₆, Ce₂Si₂O₇, CeTa₃O₉, Ce₂Mo₄O₁₅, CeTaO₄, CeNb₃O₉, CeNbO₄, or a combination thereof; and
gas diffusion layers (GDLs) separated from the PEM by the catalyst layers; and
bipolar plates connected to the GDLs.

13. (canceled)

14. (canceled)

15. The fuel cell of claim 12, wherein a loading level of the peroxide decomposition radical scavenger material onto the PEM is in a range of 0.1 to 200 μg cm⁻².

16. (canceled)

17. (canceled)

18. (canceled)

19. (canceled)

20. (canceled)

21. The fuel cell PEM of claim 1, wherein the Ce—Mn mixture is Ce_{0.25}Mn_{0.75}.

22. The fuel cell PEM of claim 1, wherein the Ce—Mn mixture is Ce_{0.5}Mn_{0.5}.

23. The fuel cell PEM of claim 1, wherein the Ce—Mn mixture is Ce_{0.75}Mn_{0.25}.

24. The fuel cell PEM of claim 1, wherein M is Nb, Ta, Si, Ga, Sn, W, In, or a combination thereof.

25. The fuel cell PEM of claim 1, wherein M is Nb, Ta, Si, or a combination thereof.

26. The fuel cell PEM of claim 1, wherein M/MOₓ (1≤x≤3) is Nb₂O₅, Ta₂O₅, or a combination thereof.

27. The fuel cell PEM of claim 1, wherein M/MOₓ (1≤x≤3) is SiO₂, H₄SiO₄, H₂SiO₃, or a combination thereof.

28. The fuel cell PEM of claim 7, wherein the peroxide decomposition radical scavenger material is Ce₃TaO₇, Ce₂Zr₂O₇, Ce₂Ti₂O₇, Ce₂TiO₅, Ce₂WO₆, Ce₂Si₂O₇, or a combination thereof.

29. The fuel cell PEM of claim 7, wherein the peroxide decomposition radical scavenger material is Ce₃TaO₇, Ce₂Zr₂O₇, Ce₂Ti₂O₇, or a combination thereof.

30. The fuel cell PEM of claim 7, wherein the peroxide decomposition radical scavenger material is Ce₃TaO₇.

31. The fuel cell PEM of claim 12, wherein the peroxide decomposition radical scavenger material is Ce₃TaO₇, Ce₂Zr₂O₇, Ce₂Ti₂O₇, Ce₂TiO₅, Ce₂WO₆, Ce₂Si₂O₇, or a combination thereof.

32. The fuel cell PEM of claim 12, wherein the peroxide decomposition radical scavenger material is Ce₃TaO₇, Ce₂Zr₂O₇, Ce₂Ti₂O₇, or a combination thereof.

33. The fuel cell PEM of claim 12, wherein the peroxide decomposition radical scavenger material is Ce₃TaO₇.
